(19) United States
(12) Patent Application Publication
(10) Pub. No.: US 2010/0308601 A1
(43) Pub. Date: Dec. 9, 2010

(54) Permanent Magnet Motion Amplified Motor and Control System

(75) Inventor: Michael K. Walden, North Las Vegas, NV (US)

Correspondence Address: LOEB & LOEB, LLP, 321 NORTH CLARK, SUITE 2300, CHICAGO, IL, 60654-4746, US

(73) Assignee: Wardenclyffe Technologies LLC, Long Beach, CA (US)

(21) Appl. No.: 12/478,550

(22) Filed: Jun. 4, 2009

(51) Int. Cl. H02K 7/18; H02K 21/02; H02K 7/09; B60K 8/00; H02N 11/00

(52) U.S. Cl. 290/1 R; 310/152; 310/90.5; 180/54.1; 415/916

(57) ABSTRACT

A permanent magnet motor operated by the magnetic interaction between two or more permanent magnets, and a control system therefor, is provided. The permanent magnet motor may be a piston motor having a magnetic piston assembly mounted on a crank shaft, and a rotatable cam shaft having a cam magnet corresponding to the piston assembly. When the cam shaft rotates about an axis, the poles of the cam magnet alternatingly face the adjacent magnetic pole of the corresponding piston magnet. The magnetic field interactions between the piston magnet and the cam magnet cause the piston to reciprocate within the cylinder. The permanent magnet motor may also be a rotary motor comprising a rotor having a plurality of rotor magnets, and a stator having a stator magnet. A stator motor drives the stator causing the rotor to rotate in response to alternating interactions between magnetic fields of the stator magnet and rotor magnets. A vehicle comprising a permanent magnet motor is also disclosed.

### BACKGROUND OF THE INVENTION

1. Field of the Invention

The present invention relates to magnetic motors, and in particular to a permanent magnet motor operated by the magnetic interaction between two or more permanent magnets, and a control system therefor.

2. Background Information

In recent years, the development of electric vehicles is exploding. Such electric vehicles use an electric drive motor as a power source. Conventional electric drive motors are designed to generate power by directly rotating a rotor by electromagnetic force from batteries or other electrical input.

The electric drive motors of such a type, however, lead naturally to an increase in the weight of a rotor in order to generate a greater output and, as a consequence, suffer from the disadvantages that the weight of the portion corresponding to a rotary assembly section becomes heavy. This is also true of their power supplies. In addition, conventional power transmission mechanisms for transmitting drive power from a power source to the wheels in a typical internal combustion piston engine cannot generally be applied to electric vehicles. Because electric drive motors generally require a specially designed power transmission mechanism, greater burdens are imposed in designing of electric vehicles.

Also, a variety of unwanted resistances often results from the structure of conventional internal combustion piston engines. These resistances may be caused by, for example, air intake of an air cleaner; compression in a cylinder; friction of a piston against an inner wall of a cylinder; and the operation of cooling fans, water pumps and/or oil pumps. The loss of energy due to such resistances can greatly reduce the energy efficiency of internal combustion piston engines. The efficiency of internal combustion piston engines may be further reduced by an increase in the overall weight of the engine from the cooling mechanism which is required to cool the engine down from the large amounts of heat generated by the engine itself.

Given these and other problems inherent in conventional internal combustion piston engines, it is desirable to design an engine capable of reducing or eliminating resistances inherent in conventional internal combustion piston engines and conventional electric motors, reducing the weight corresponding to a rotary assembly, and reducing air pollution such as emitted by conventional gas vehicles. A reduction in required input power and increased range with lower mass is also desirable in power transmission mechanisms for use with conventional internal combustion piston engines, as is achieving improved efficiency in utilizing energy in current engines.

### SUMMARY OF THE INVENTION

A piston motor is provided having a piston assembly mounted on a crank shaft, the piston assembly comprising a cylinder having a first axis, and a piston positioned inside the cylinder, the piston configured to reciprocate axially within the cylinder, wherein the piston includes a piston magnet having a first magnetic pole. The piston motor further includes a rotatable cam shaft disposed along a second axis perpendicular to the first axis and a cam magnet corresponding to the piston assembly. The cam magnet, which has a first magnetic pole and a second magnetic pole, is mounted on the cam shaft such that when the cam shaft rotates along the second axis, the first and second magnetic poles of the cam magnet alternatingly faces the first magnetic pole of the corresponding piston magnet. When the first and second magnetic poles of the cam magnet alternatingly face the first magnetic pole of the corresponding piston magnet, the field interactions between the first magnetic pole of the piston magnet and the magnetic poles of the corresponding cam magnet cause the corresponding piston to reciprocate within the cylinder.

The piston motor may further comprising a flywheel for maintaining the reciprocating movement of the piston within the cylinder, and/or a booster coil coupled to the piston for enhancing output power of the piston motor. The piston motor may also include a plurality of piston assemblies mounted on the crank shaft. In one implementation, the piston assemblies are disposed in two rows arranged in a v-shape, and each row has a corresponding cam shaft. In another implementation, the piston assemblies may be disposed in a single row.

In a preferred embodiment, the piston motor may include a control device for changing the magnetic geometry relationship between the piston magnets and the cam magnets This control device may include a drive belt in communication with the cam shaft and the crank shaft, a throttle unit disposed along the drive belt, and one or more idler units disposed along the drive belt, wherein the magnetic geometry relationship between the piston magnet and the cam magnet would change upon actuation of the throttle unit. In an alternative implementation, the control devices may comprise a throttle motor having a motor shaft rotationally coupled to an upper shaft and fixedly coupled to a lower shaft, and a motor control unit electrically connected to the throttle motor, wherein the upper shaft is coupled to the cam shaft and the lower shaft is couple to the crank shaft. In such an implementation, the magnetic geometry relationship between the piston magnet and the cam magnet changes in response to activation of the throttle motor.

Also provided is a rotary motor comprising a rotor having a plurality of rotor magnets mounted thereon, each rotor magnet having a first magnetic pole and a second magnetic pole. The rotary motor further includes a stator adjacent to the rotor comprising a stator magnet and a stator motor, the stator magnet having a first magnetic pole that is the same polarity as the first magnetic pole of the rotor magnets, and a second magnetic pole that is the same polarity as the second magnetic pole of the rotor magnets. In this embodiment, the stator motor drives the stator, causing the rotor to rotate in response to alternating interactions between magnetic fields of the stator magnet and magnetic fields of the rotor magnet.

The rotary motor may further include a booster coil coupled to the stator for enhancing output power of the rotary motor, and/or a plurality of stators adjacent to the rotor. The rotary motor may further include a plurality of rotors, each rotor corresponding to at least one stator. The stator motor may be a stepper motor which is in communication with a controller for controlling the speed of the stator motor.

These and other features and implementations of the present disclosure will be apparent to those of ordinary skill in the art having the present drawings, specifications, and claims before them. It is intended that all such additional systems, methods, features, and advantages be included within this description, be within the scope of the disclosure, and be protected by the accompanying claims.

### BRIEF DESCRIPTION OF THE DRAWINGS

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a top view of a permanent magnet rotary motor in accordance with a first embodiment of the invention.

FIG. 2 is a perspective view of the permanent magnet rotary motor of FIG. 1.

FIG. 3A is a side view of the oscillating stator of FIG. 1 in a neutral state relative to the rotor.

FIG. 3B is a side view of the oscillating stator of FIG. 1 in a first magnetically biased state relative to the rotor.

FIG. 3C is a side view of the oscillating stator of FIG. 1 in a second magnetically biased state relative to the rotor.

FIG. 4 is a top view of a permanent magnet rotary motor in accordance with a second embodiment of the invention.

FIG. 5 is a perspective view of the permanent magnet rotary motor of FIG. 4.

FIG. 6A is a side view of the rotating stator of FIG. 4 in a neutral state relative to the rotor.

FIG. 6B is a side view of the oscillating stator of FIG. 4 in a first magnetically biased state relative to the rotor.

FIG. 6C is a side view of the oscillating stator of FIG. 4 in a second magnetically biased state relative to the rotor.

FIG. 7 is a top view of a permanent magnet rotary motor in accordance with a third embodiment of the invention.

FIG. 8 is a perspective view of the permanent magnet rotary motor of FIG. 7.

FIG. 9 is a side view of a permanent magnet rotary motor in accordance with a fourth embodiment of the invention.

FIG. 10 is a perspective view of the permanent magnet rotary motor of FIG. 9.

FIG. 11 is a front view of a permanent magnet piston motor in accordance with a fifth embodiment of the invention.

FIG. 12 is a perspective view of a row of piston assemblies that may be used in connection with the permanent magnet piston motor of FIG. 11.

FIG. 13 is a side view of the row of piston assemblies illustrated in FIG. 12.

FIG. 14 is a top view of the permanent magnet piston motor of FIG. 11.

FIG. 15 is a perspective view of the permanent magnet piston motor of FIG. 11.

FIG. 16 illustrates a first embodiment of a control system for use in connection with a permanent magnet piston motor.

FIG. 17 illustrates the control system of FIG. 16 with cam units out of phase.

FIG. 18 illustrates a second embodiment of a control system for use in connection with a permanent magnet piston motor.

FIG. 19 is an enlarged side cross-sectional view of one implementation of a piston assembly for use in a permanent magnet piston motor.

FIG. 20 illustrates an example implementation of a linear bearing system for use in connection with a permanent magnet piston motor.

FIG. 21 schematically illustrates a vehicle driven by a permanent magnet motor.

FIG. 22 illustrates an example implementation of a power supply unit using a permanent magnet motor.

### DETAILED DESCRIPTION

While the present disclosure may be embodied in many different forms, the drawings and discussion are presented with the understanding that the present disclosure is an exemplification of the principles of one or more inventions and is not intended to limit any one of the inventions to the embodiments illustrated. References to particular magnet poles (i.e., north or south) in the description are for purposes of explanation, and one of skill in the art having the present drawings, specifications, and claims before them would understand that the particular references to magnet poles in the below description may be reversed. Similarly, references to direction or position (e.g., up and down) are also made for ease of description, and are not intended to limit the invention.

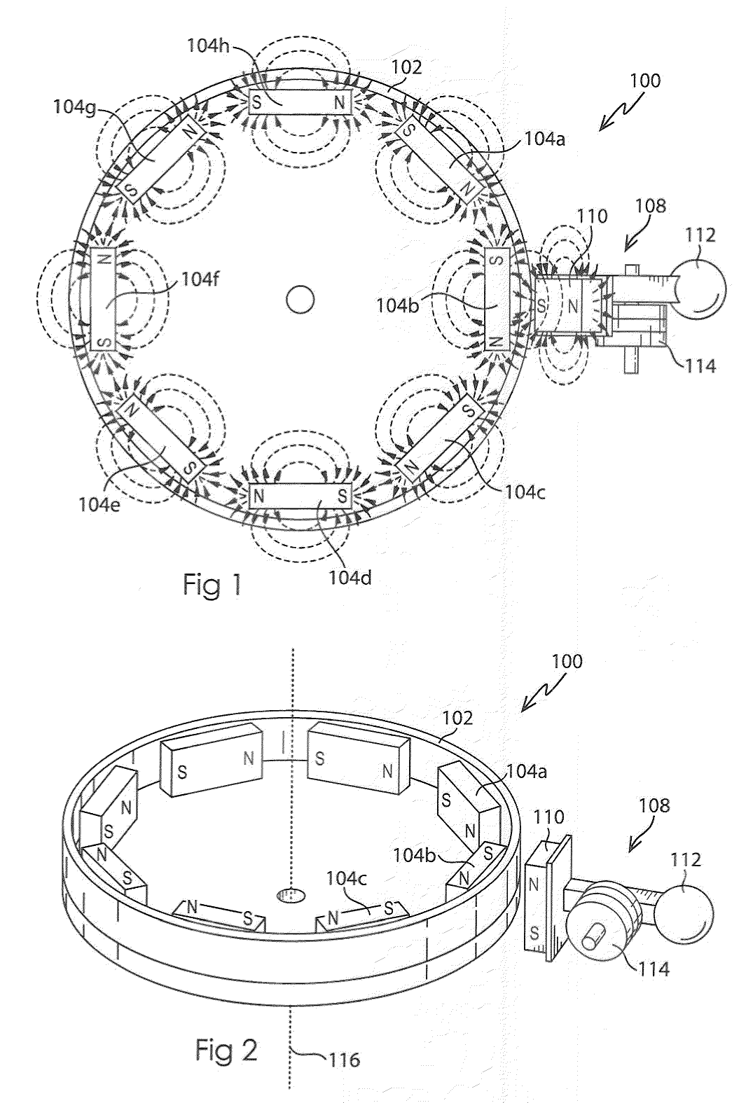

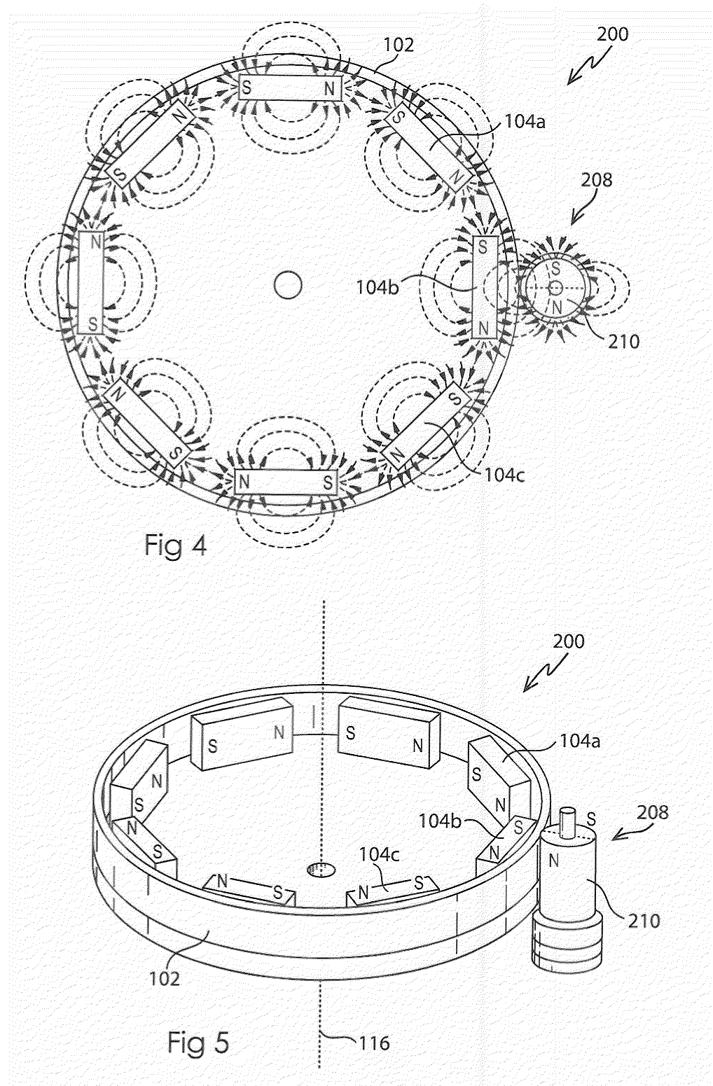

FIG. 1 illustrates a top view of a permanent magnet rotary motor 100 in accordance with a first embodiment of the invention, and FIG. 2 is a perspective view of the permanent magnet rotary motor of FIG. 1. The permanent magnet rotary motor 100 of FIG. 1 includes a rotor 102 having a plurality of rotor magnets 104 mounted along the inside of the rotor 102. While the embodiment illustrated in FIG. 1 includes eight rotor magnets 104a-h, one of ordinary skill in the art having the present drawings, specifications, and claims before them would understand that more or fewer rotor magnets may be used. The motor 100 further includes an oscillating stator 108 adjacent the rotor 102 at its periphery. While the embodiment illustrated in FIG. 1 uses an oscillating stator, as would be understood by one of skill in the art having the present drawings, specifications, and claims before them, other types of stators may be used. For example, as described in further detail below with respect to FIGS. 4-6, a rotating stator may be used. The oscillating stator 108 includes one or more stator magnets 110, a counterbalance 112 and a motor 114. The motor 114 may be, for example, a linear, single phase or poly-phase AC motor, a brush DC motor or a brushless DC motor. Preferably, the motor is a 114 a low power motor such as a stepper motor. However, any type of conventional motor may be used to drive the stator 108.

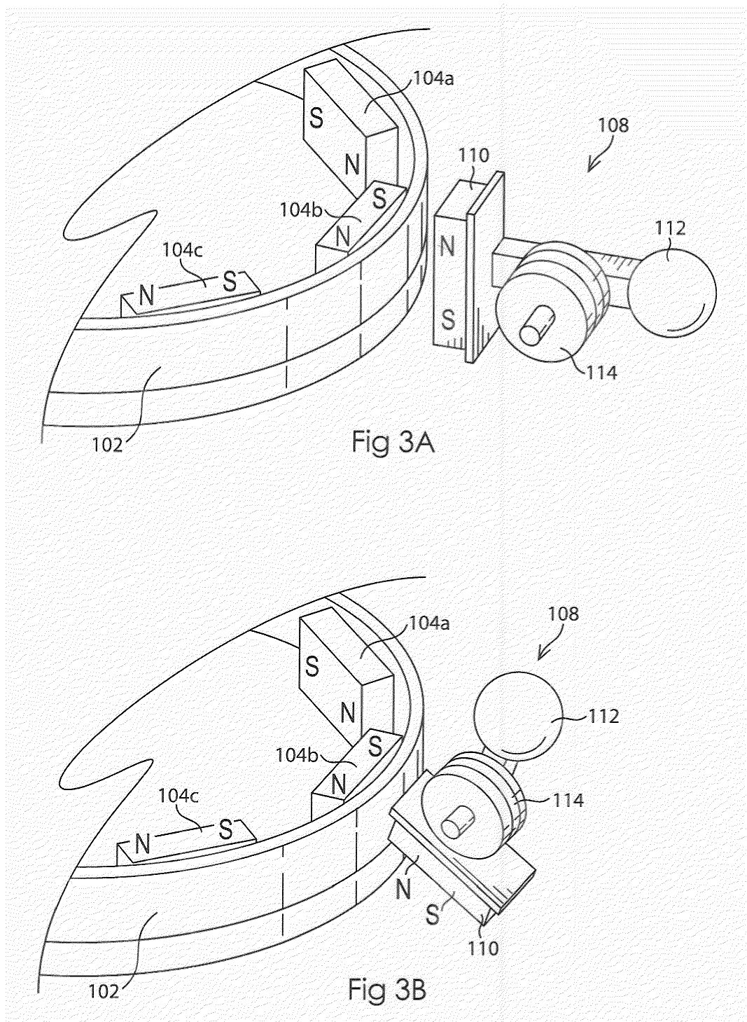

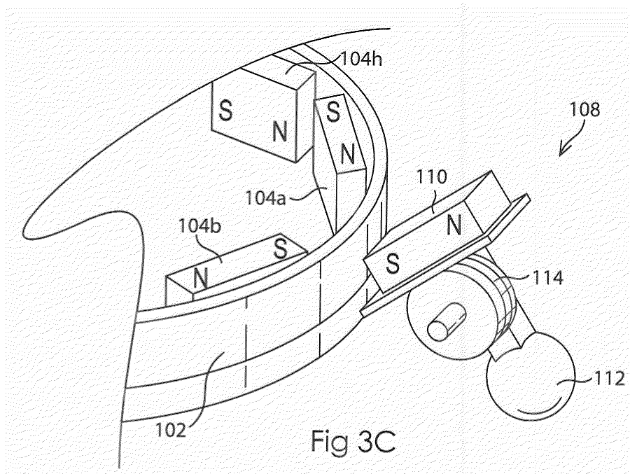

In operation, the rotor 102 may be located adjacent to one or more stator magnets 110, which stator magnets 110 are driven to move in synchronization with the rotor 102 so as to generate an alternating attraction and repulsion of the rotor magnets 104a-h at the periphery of the rotor 102 causing the rotor 102 to turn in a consistent direction on its center or axis of rotation 116. Referring specifically to FIG. 1, the rotor 102 is adjacent to the stator magnet 110 such that when the magnetic fields of the rotor magnets 104 a-b adjacent the stator 108 interact with the magnetic field of the stator magnet 110, as the stator 108 oscillates, the alternating attraction and repulsion of the magnets 104, 110 causes the rotor 102 to turn in a consistent direction on its center or rotation 116. Accordingly, the stator magnet 110 is preferably close enough to the rotor 102 such that the magnetic field of the stator magnet 110 interacts with the magnetic field of at least one adjacent rotor magnet 104 (e.g., 104b). The operation is explained in detail below with respect to FIGS. 3A-3C.

FIGS. 3A-C show the position of the oscillating, stator 108 relative to the rotor 102 in three different magnetically biased states. First, FIG. 3A shows the oscillating stator 108 of FIG. 1 in a neutral magnetic state relative to the rotor. This neutral state occurs when the stator magnet 110 is positioned such that the net magnetic force between the stator magnet 110 and an adjacent rotor magnet 104b is zero. This would occur when, as shown in FIG. 3A, the north pole (N) and the south pole (S) of the stator magnet 110 are equidistant to the north pole of an adjacent rotor magnet 104b and the south pole of the same rotor magnet 104b (or a second adjacent rotor magnet, if applicable).

When the net magnetic force on the stator magnet 110 from the adjacent rotor magnet(s) 104b is zero, as shown in FIG. 3A, the motor 114 can drive the stator 108 with very little power required to run the motor. Accordingly, it is preferable for the motor 114 to drive the stator 108 at or near this neutral state. When the stator 108 is in such a neutral state, the stator 108 is driven up or down to create magnetically biased states. As illustrated in FIG. 3B, the magnetic field of the north pole of the stator magnet 110 is in a position wherein it interacts with the north pole and south pole fields of the adjacent rotor magnet(s) 104b. When in this position, the north pole of the stator magnet 110 repels the north pole of the adjacent rotor magnet 104b, and at the same time attracts the south pole of the adjacent rotor magnet 104b, thus forcing the rotor 102 clockwise. The stator 108 then returns to a neutral state at which point the motor 114 drives the stator 108 upward to the next magnetically biased position, as illustrated in FIG. 3C. The south pole of the stator magnet 110 then repels the south pole of an adjacent rotor magnet 104b and attracts the north pole of the next adjacent rotor magnet 104a (which will become adjacent to the stator magnet since the rotor will continue to rotate clockwise), forcing the rotor 102 to continue to rotate in a clockwise direction.

FIG. 4 is a top view of a permanent magnet rotary motor 200 in accordance with a second embodiment of the invention, and FIG. 5 is a perspective view of the permanent magnet rotary motor of FIG. 4. The permanent magnet rotary motor 200 illustrated in FIGS. 4 and 5 is similar to that of FIGS. 1 and 2, however it uses a different type of stator 208. The stator 208 of FIGS. 4-5 is a rotating stator 208 which includes a cylindrical stator magnet 210 and a stepper motor 114. The cylindrical stator magnet 210 is preferably diametrically magnetized such that half of the cylindrical stator magnet 210 divided along a diameter corresponds to the north pole (N) of the magnet, and the other half of the cylindrical stator 208 corresponds to the south pole (S).

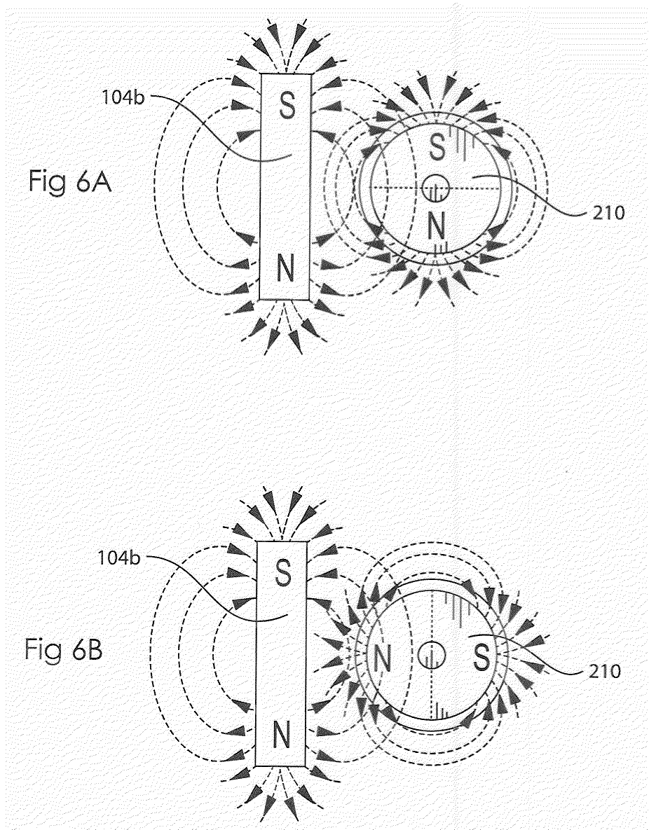

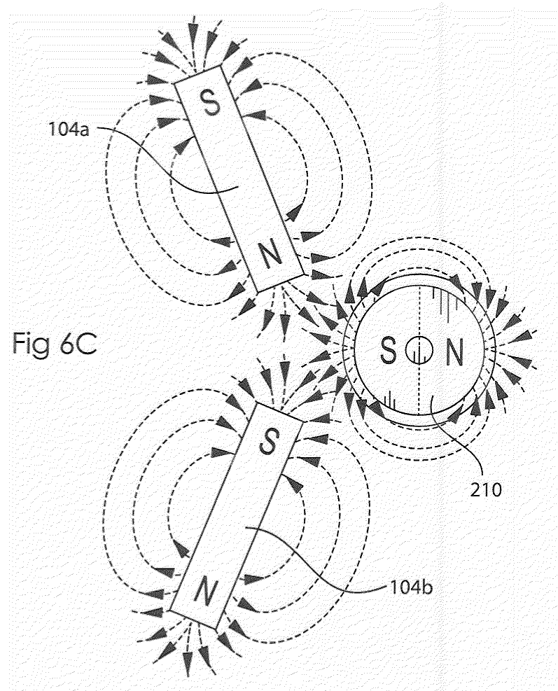

As previously explained, the rotor 102 is adjacent to the stator 208 such that when the respective magnetic fields of the rotor magnet(s) 104b adjacent the stator 208 interact with the magnetic field of the stator magnet 210, as the stator magnet 208 rotates, the alternating attraction and repulsion of the magnet(s) 104, 210 causes the rotor 102 to turn in a consistent direction on its center or rotation 116. This operation is explained in detail below with respect to FIGS. 6A-6C.

FIGS. 6A-C show the position of the rotating cylindrical stator magnet 208 relative to adjacent rotor magnet(s) 104 in three different magnetically biased states. First, FIG. 6A shows the stator 208 of FIG. 4 in a neutral state relative to the rotor 102. This neutral state occurs when the stator magnet 210 is positioned such that the net magnetic force between the stator magnet 210 and the adjacent rotor magnet(s) 104b is zero. This would occur when, as shown in FIG. 6A, the net magnetic force between the north poles (N) of the stator magnet 210 and an adjacent rotor magnet 104b, and the south poles (S) of the stator magnet 210 and the adjacent rotor magnet 104b, is zero. In FIG. 6A, this occurs because the respective repelling forces between S-S and N-N are equal.

As previously explained with respect to the oscillating stator, when the net magnetic force between the stator magnet 210 and the rotor magnets 104 is zero, the motor 114 can drive the stator 208 with very little power required to run the motor 114. Accordingly, again, it is preferable for the motor 114 to drive the stator 208 at or near this neutral state. When the stator 208 is in its neutral state or position, the stator magnet 210 is driven rotatingly on its axis of rotation to create alternating neutral and magnetically biased states. As illustrated in FIG. 6B, the stator magnet 210 has been rotated such that the north pole (N) of the stator magnet 210 is facing the adjacent rotor magnet 104b. When in this position, the north pole of the stator magnet 210 repels the north pole of the adjacent rotor magnet 104b, and at the same time attracts the south pole of the adjacent rotor magnet 104b, thus forcing the rotor 102 clockwise. The stator 208 then returns to the neutral position at which point the motor 114 drives the stator 208 rotatingly to the next magnetically biased position, as illustrated in FIG. 6C. The south pole of the stator magnet 210 then repels the south pole of the adjacent rotor magnet and attracts the north pole of the next adjacent rotor magnet (which would then become adjacent to the stator magnet since the rotor will continue to rotate clockwise), forcing the rotor 102 to continue to rotate in a clockwise direction.

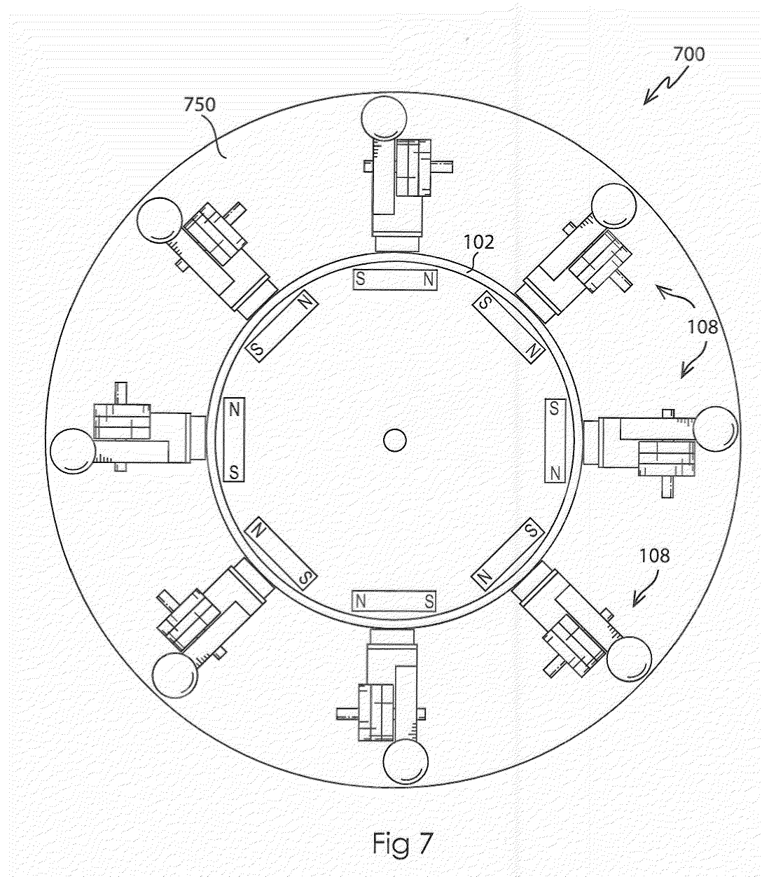

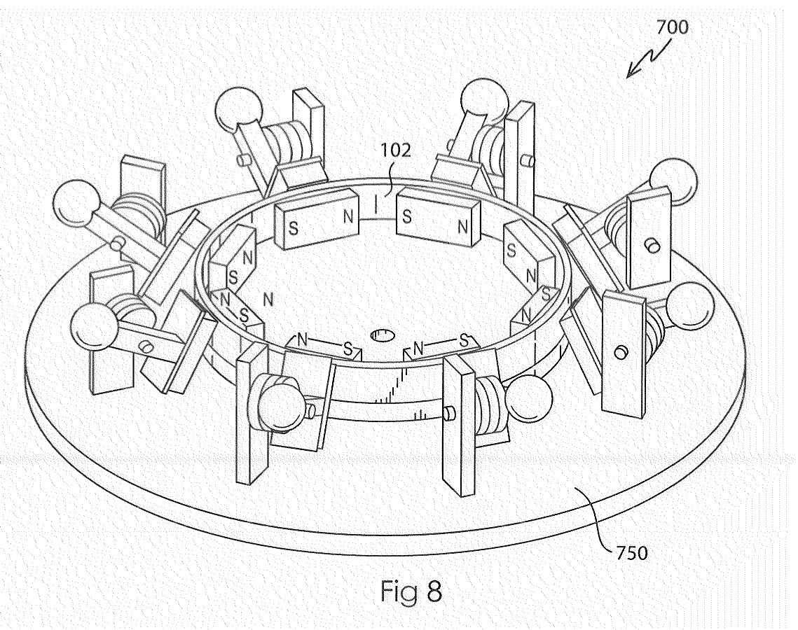

FIG. 7 is a top view of a permanent magnet rotary motor 700 in accordance with a third embodiment of the invention. The embodiment of FIG. 7 illustrates a single rotor similar to the rotor 102 of FIG. 1, with a plurality of oscillating stators 108 (referred to as a multi-unit stator 750), rather than a single stator as in FIG. 1. While FIG. 7 illustrates eight stators 108 evenly spaced, one of skill in the art having the present drawings, specifications, and claims before them would understand that any number of stators may be used, and the placement around the rotor need not necessarily be evenly spaced as shown. One of skill in the art having the present specification before them would also understand that different types of stators, such as the rotating stator 208 of FIGS. 4-5, may be used instead of, or in addition to, the oscillating stators 108 in a multi-unit stator 750. The additional stators increase the power output of the motor. FIG. 8 is a perspective view of the permanent magnet rotary motor of FIG. 7.

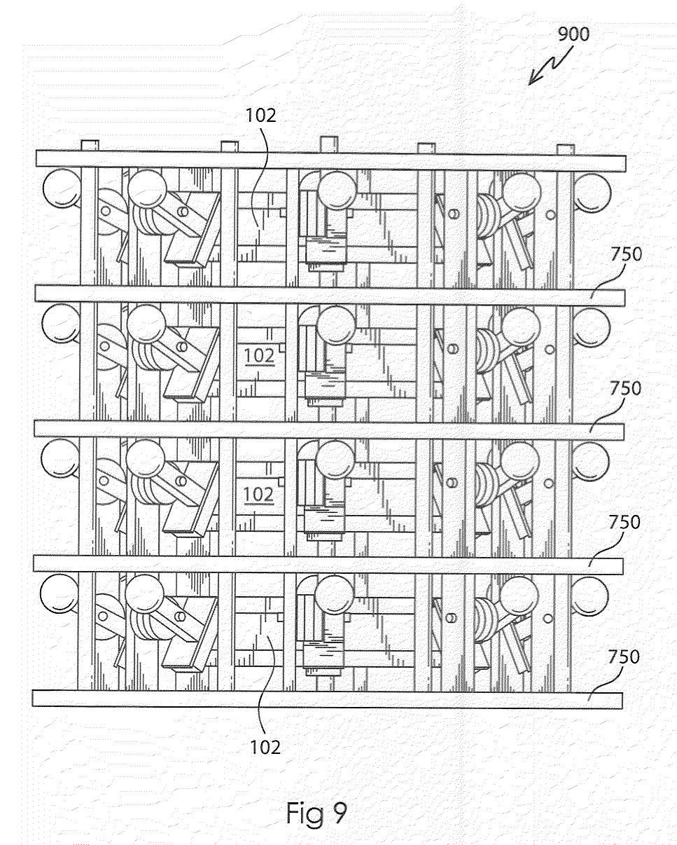

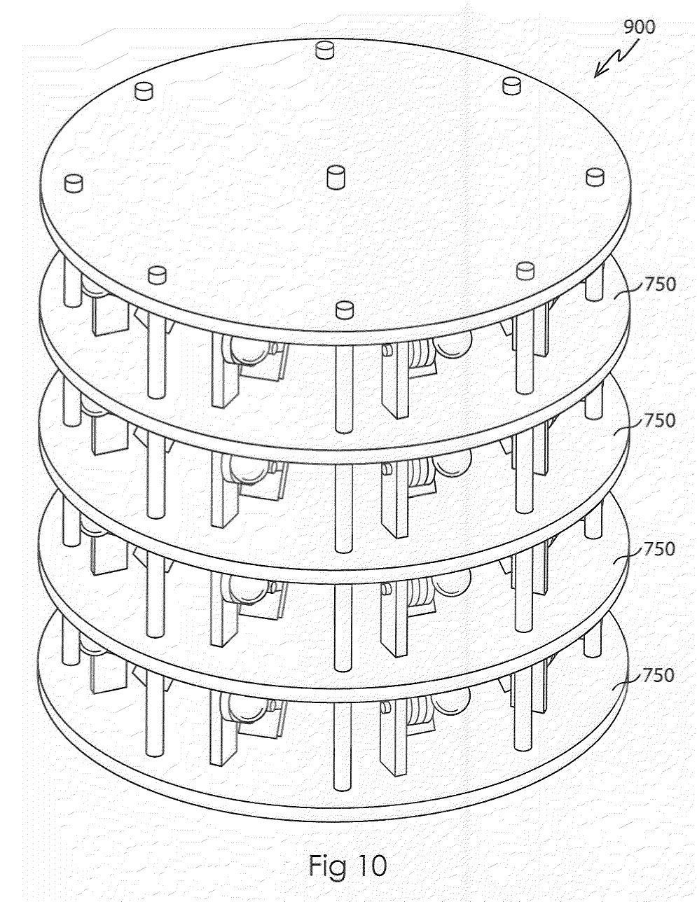

FIG. 9 is a side elevational view of a permanent magnet rotary motor 900 in accordance with a fourth embodiment of the invention. The embodiment of FIG. 9 includes a plurality of vertically stacked rotors 102, each corresponding to a multi-unit stator 750. While FIG. 9 illustrates four such rotor/multi-unit stator units, one of skill in the art having the present drawings, specifications, and claims before them would understand that any number of such rotor/multi-unit stator units may be used. One of skill in the art having the present specification before them would also understand that different types of stators, such as the rotating stator 208 of FIGS. 4-5, may be used instead of, or in addition to, the oscillating stators 108 shown in FIG. 9. Further, each of the plurality of rotors 102 may correspond to a single unit stator (as shown in FIG. 1 and FIG. 4) may be used as well. FIG. 10 is a perspective view of the permanent magnet rotary motor 900 of FIG. 9.

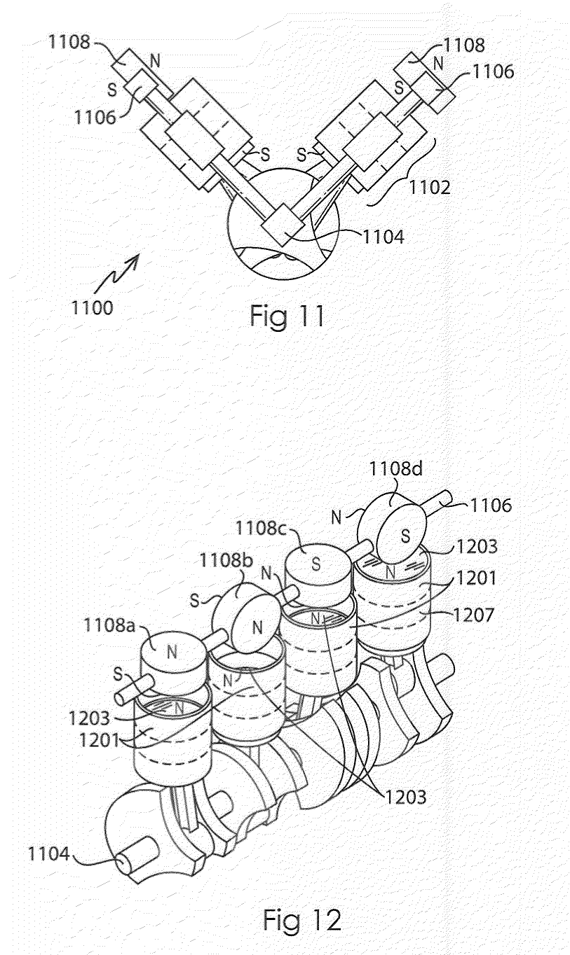

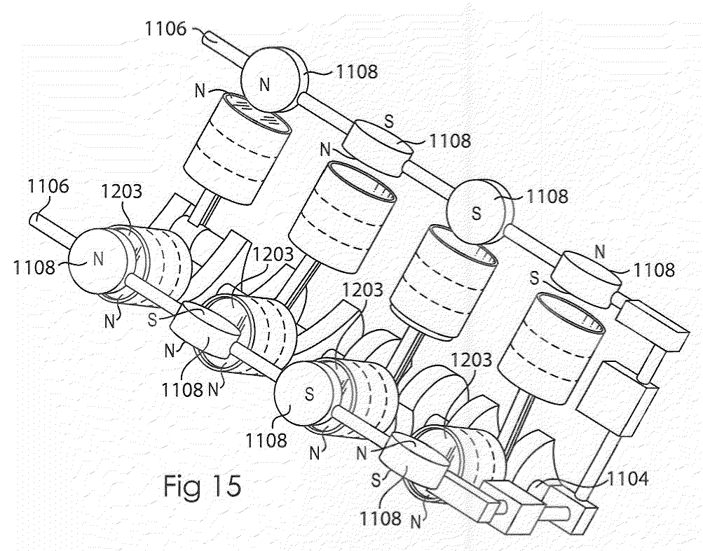

FIG. 11 is a front view of a permanent magnet piston motor 1100 in accordance with a fifth embodiment of the invention. The permanent magnet piston motor 1100 of FIG. 11 includes two rows of piston assemblies 1102 mounted on a crank shaft (or simply “crank”) 1104, and a cam shaft (or simply “cam”) 1106 corresponding to each row on which at least one permanent cam magnet 1108 corresponding to each piston assembly 11102 is mounted. In the embodiment illustrated in FIG. 11, the rows of piston assemblies 1102 are arranged in a v-shaped configuration. However, it is understood that the piston assemblies may be arranged in any known cylinder arrangement, such as, for example, a straight, flat or radial configuration. Each row preferably has four piston assemblies 1102, resulting in an eight cylinder motor. However, it is understood that rather than eight cylinders, the motor may comprise a different structure, such as, for example, a four- or six-cylinder structure. FIG. 14 is a top view of the permanent magnet piston motor 1100 of FIG. 11 illustrating an eight cylinder implementation, and FIG. 15 is a perspective view of the implementation of a permanent magnet piston motor 1100 of FIG. 14. While the particular structure illustrated in FIG. 11 is a preferred embodiment, one of skill in the art having the present specification before them would understand that any known structure used in conventional piston engines may be used.

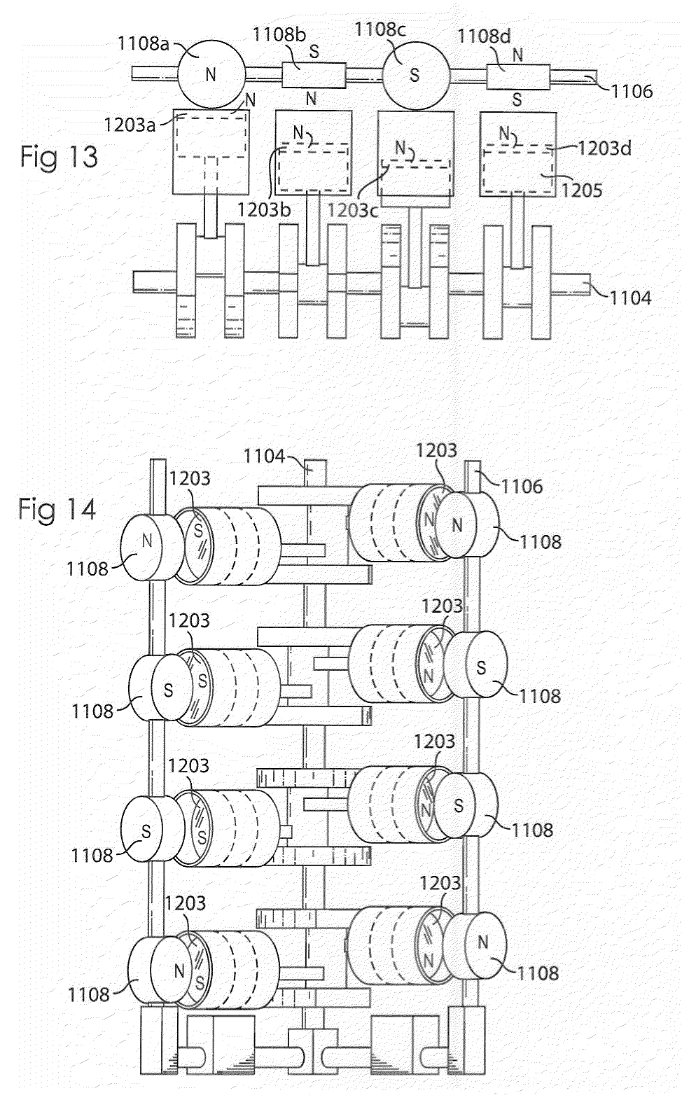

FIG. 12 is a perspective view of a row of four piston assemblies 1102 that may be used in connection with the permanent magnet piston motor 1100 of FIG. 11. As better illustrated in FIG. 12, each piston assembly 1102 includes a cylinder 1201 with at least one permanent magnet 1203 mounted on a piston 1205 in each cylinder 1201 (referred to as a piston magnet). This can also be seen in FIG. 13, which illustrates a side elevational view of the row of four piston assemblies of FIG. 12. Each piston assembly 1102 is preferably mounted on the crank shaft 1104 adjacent and in line with a corresponding cam magnet 1108 mounted on the corresponding cam shaft 1106.

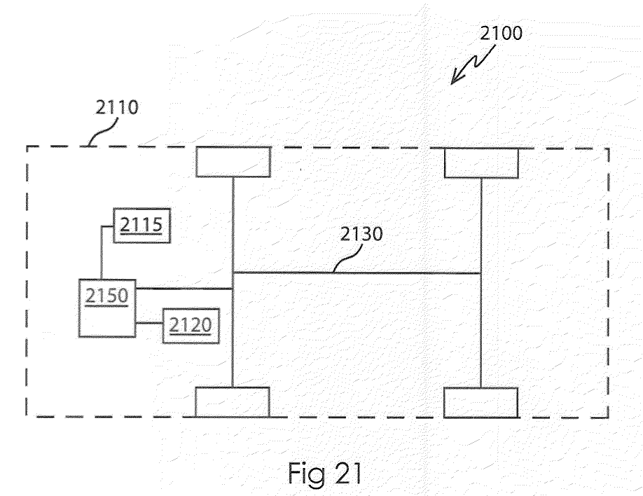

In one implementation of a permanent magnet piston motor 1100 (shown in FIG. 12), the cylinders 1201 may include magnetic repulsion centering rings 1207 mounted on, or inside, the cylinders 1201 to keep the pistons 1205 centered within the cylinders. The magnetic repulsion centering rings 1207 are made of a band of magnetic material that has a magnetic polarity on the inside portion of the band (toward the piston) that is the same as the top part of the piston magnet 1203 (i.e., the part that interacts with the cam magnets 1108). The repulsion force between the centering rings 1207 and the corresponding piston magnets 1203 helps keep the corresponding piston 1205 axially centered and running smoothly within the cylinder 1201. Alternatively, small wheels, roller balls, or a linear bearing system may be used to help keep the piston 1205 axially centered and running smoothly within the cylinder 1201. FIG. 20 illustrates an example implementation of a linear bearing system for use in connection with a permanent magnet piston motor.

In FIG. 20, a guide track 2010 may be mounted on an inner wall of a cylinder. Alternatively, as illustrated in the example implementation of FIG. 20, a planar plate 2015 along which the piston may reciprocate may be used in place of a cylinder. Where the planar plate 2015 is used, the guide track 2010 may be mounted on the planar plate 2015. Whether a cylinder or planar plate 2015 is used, the piston 1205, on which the piston magnet 1203 is mounted, includes a guide bearing unit or “sled” 2020 mounted on the piston 1205. In order to stabilize and guide the piston 1205 along the cylinder or planar plate 2015, the sled 2020 runs along the guide track 2010 as the piston reciprocates, with little to no friction between the guide track 2010 and the planar plate 2015.

Operation of the permanent magnet piston motor 1100 of FIG. 11 is described in detail below with respect to FIG. 13, which illustrates a side view of the row of piston assemblies 1102 illustrated in FIG. 12. Generally, the magnetic field of one pole of a piston magnet 1203 interacts with the magnetic fields of the corresponding cam magnet(s) 1108 so as to cause the corresponding piston 1205 to reciprocate. When each of the pistons 1205 reciprocate in combination with each other, the crank shaft 1104 is forced to rotated, thus converting reciprocal motion into rotational motion, similar to a conventional internal combustion piston engines. As the cam shaft 1106 rotates, the cam magnets 1108 mounted upon it rotate and change alternately the respective magnetic poles facing the respective piston magnets 1203. The alternating attraction and repulsion of the piston magnets 1203 relative to the cam magnets 1108 drive the operation of the motor. This will be more specifically described below.

As illustrated in FIG. 13, for a cam shaft 1106 having four cam magnets 1108 mounted thereon, each of the cam magnets 1108 is positioned such that the north and south poles of each cam magnet 1108 is 90 degrees out of phase relative to the adjacent cam magnets 1108. One of skill in the art having the present drawings, specifications, and claims before them would further understand that the positioning of each cam magnet 1108 on the cam shaft 1106 depends on how many cam magnets 1108 are mounted on the cam shaft 1106. Thus, with three cam magnets 1108, each would be 120 degrees out of phase relative to the adjacent magnets 1108. Similarly, with eight cam magnets 1108, each would be 45 degrees out of phase relative to the adjacent magnets 1108, and with six cam magnets 1108, each would be 60 degrees out of phase relative to the adjacent magnets 1108.

Returning to FIG. 13, when the first cam magnet 1108a as shown in FIG. 13 is positioned such that the north pole is facing outward (as viewed looking onto the page), the north pole of the second cam magnet 1108b is facing downward (90 degrees counterclockwise from the first cam magnet), the north pole of the third cam magnet 1108c is facing inward (as viewed looking onto the page, which is 90 degrees counterclockwise from the second cam magnet 1108b), and the north pole of the fourth cam magnet 1108d is facing upward (up to 90 degrees counterclockwise from the third cam magnet 1108c). In the illustrated example, each of the piston magnets 1203 has its north pole facing upward, toward the cam 1106, such that the magnetic field of the cam magnets 1108 interact with the north pole field of the respective piston magnets 1203. So at the point of time illustrated in FIG. 13, the first and third piston magnets 1203a,c, respectively, will not be experiencing any net force from the corresponding cam magnets, 1108a,c, respectively; the second piston magnet 1203b will be repelled away from its corresponding cam magnet 1108b, and the fourth piston magnet 1203d will be attracted toward its corresponding cam magnet 1108d. As would be understood by one of skill in the art having the present drawings, specifications, and claims before them, a flywheel may be mounted on the crank shaft 1104 causing the pistons 1205 to continue their reciprocating movement during intervals of null net magnetic force.

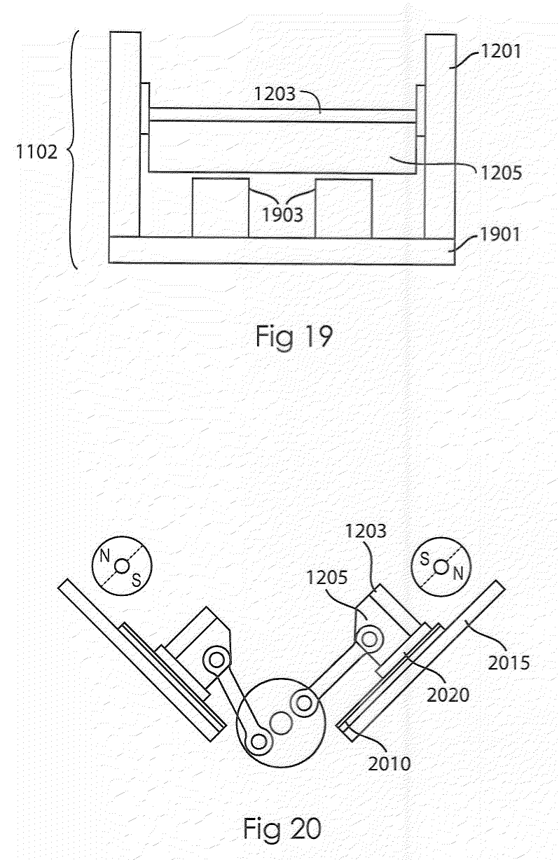

In addition to the components described with respect to each of the foregoing embodiments and examples, a booster coil may further be included in order to boost the various magnetic attraction or repelling forces. Specifically, the booster coil may use intermittent pulses of input electrical energy to further boost the output power of the motor by employing a pulsed charge of electrical energy to generate a timed electromagnetic pulse to either attract or repel the magnets of the rotor or piston, depending upon the motor configuration. FIG. 19 is an enlarged side cross-sectional view of one implementation of a piston assembly 1102 for use in a permanent magnet piston motor, using booster coils to boost the output power of the motor. As shown in FIG. 19, the piston assembly 1102 includes a mounting plate 1901 on which one or more booster coil units 1903 may be mounted. The booster coil units 1903 may be designed to pulse just after the point in time that the piston magnet 1203 is in close proximity to the booster coil unit(s), and is experiencing little to no net force from the corresponding cam magnets (as shown and described with respect to FIG. 13).

A control system capable of starting, stopping and controlling the speed of a permanent magnet motor is also provided. In one embodiment, a control system is provided using a means and method for changing the angle and strength of the magnetic field of the cam magnets relative to the magnetic field of the piston magnets, or, in the case of a rotary motor, changing the angle and strength of the magnetic field of the stator relative to the magnetic field of the rotor). This change in angle and strength of the relative magnetic fields changes the magnetic geometry relationships between the piston and cam magnets, or between the stator and rotor magnets, as applicable, so as to change the strength of interaction between permanent magnets, and thus the speed of the motor. The relevant changes in angle and strength of magnetic fields may be accomplished by, for example, the turning of a shaft, rod, tube, chain or gears, rollers or cogs or other device in a mechanical embodiment of the system, or moved by air, fluid or electromagnetic means.

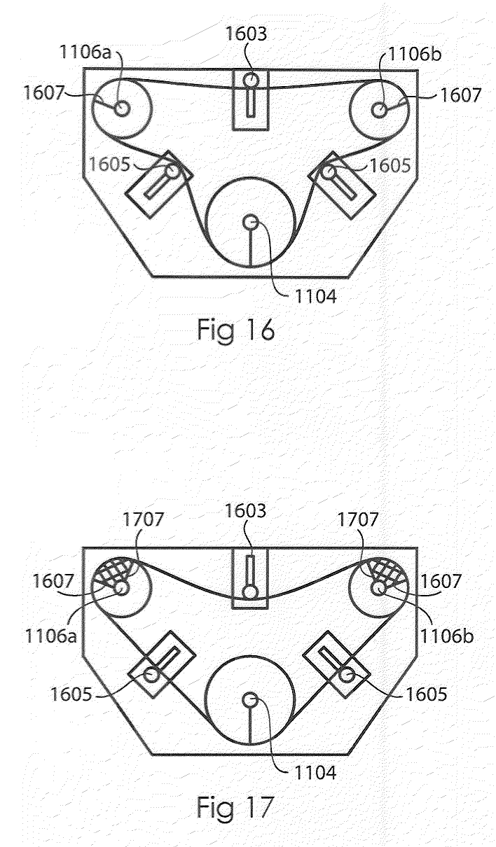

FIGS. 16 and 17 illustrate a first embodiment of a control system for use in connection with a permanent magnet piston motor. The control system of FIGS. 16 and 17 includes a drive belt 1601 for driving the cams, and a throttle unit 1603 for controlling the speed of the motor. The throttle unit is preferably a linear control actuator, but any conventional throttle unit known in the art may be used. For purposes of explanation, the drive belt is running in a counterclockwise direction, though it is understood that the direction may be clockwise. The control system further includes one or more idler units 1605 along the drive belt 1601. Each idler unit 1605 preferably comprises a tensioning spring such that during regular operation of the motor, the spring is in a resting state wherein both the compression and expansion force of the spring is zero. As explained further below, the springs of the idler will be compressed (or expanded, depending on the configuration, as will be understood by one of skill in the art having the present drawings, specifications, and claims before them) when the throttle unit 1603 is actuated.

In FIG. 16, the control system is in its “rest” position so that the magnetic geometry relationship between the piston magnets and the cam magnets, as indicated by the alignment angle notation 1605, remains in phase, allowing the motor to run “normally” as previously described. If it is desirable to stop or change the speed of the motor, the throttle unit 1603 may be actuated, as illustrated in FIG. 17. FIG. 17 illustrates the control system of FIG. 16 with the cam magnets out of phase due to a change in the magnetic geometry relationship between the piston and cam magnets. In FIG. 17, the throttle unit 1603 has been actuated (in this case, pushed downward), causing tension in the drive belt 1601, which exerts a force on the cams 1106 causing them to be displaced from their in-phase positions. In particular, the downward force on the belt at the throttle creates a clockwise force on the left cam 1106a, and a counter-clockwise force on the right cam 1106b. This displacement is illustrated by the alignment angle notations showing the change in orientation (1607 to 1707) of the cams 1106. When the cams 1106 are displaced due to the tension in the drive belt from actuation of the throttle unit 1603, the magnetic geometry between the cam magnets and the corresponding piston magnets is altered, resulting in the slowing or stopping of the motor.

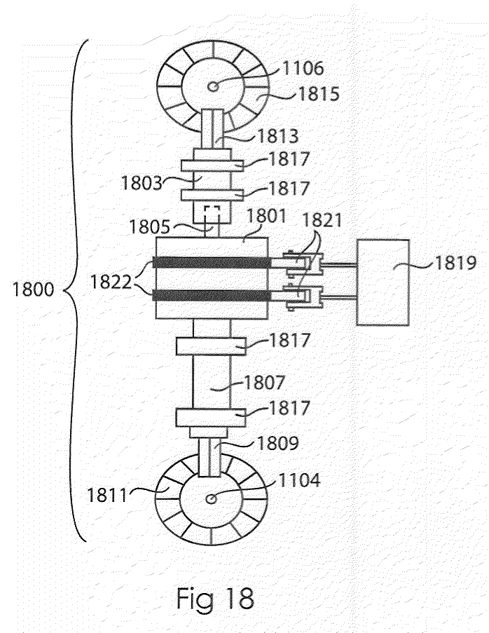

FIG. 18 illustrates a second embodiment of a control system for use in connection with a permanent magnet piston motor. The control system of FIG. 18 includes a throttle motor 1801 that is used to change the magnetic relationship between the cam and piston magnets in order to slow or stop the permanent magnet piston motor. An upper shaft 1803 is mounted on the motor shaft 1805 of the throttle motor 1801, and a lower shaft 1807 is mounted directly to the throttle motor 1801. A cam pinion 1813, which is mounted on the upper shaft 1803, is coupled to a cam gear 1815 such that when the cam pinion 1813 rotates, it causes the cam gear 1815 to drive the cam shaft 1106 of the permanent magnet piston motor. Similarly, a crank pinion 1809, which is mounted on the lower shaft 1807, is coupled to a crank gear 1811 such that when the crank pinion 1809 rotates, it causes the crank gear 1811 to drive the crank shaft 1104. During normal operation of the permanent magnet piston motor controlled by the control system of FIG. 18, the throttle motor 1801 is idle, so that the entire drive assembly 1800 (including the throttle motor 1801, the upper and lower shafts 1803, 1807, and the crank and cam pinions 1809, 1813) rotate as a unit in a plurality of bearings 1817. In this “normal” operation, the cam and the 1106 and the crank 1104 are considered to be “in phase”.

If it is desired to slow or stop the motor, a signal may be sent from a motor control unit 1819 to the throttle motor 1801 to turn a predetermined amount, thus off setting the rotation of the upper and lower shafts relative to each other, resulting in misalignment of the cam 1106 and the crank 1104. This misalignment changes the magnetic geometry relationship between the piston magnets and the cam magnets, resulting in throttling of the permanent magnet piston motor. In order for the motor control unit 1819 to remain electrically coupled to the throttle motor 1801, the throttle motor 1801 may be electrically coupled to one or more roller connection 1821. The motor control unit 1819 is electrically coupled to the roller connection 1821, which maintain electrical contact with the throttle motor 1801 via corresponding rolling ring connectors 1822 placed around the entire circumference of the throttle motor 1801. In such a configuration, the rolling ring connectors 1822 are able to maintain electrical contact with the throttle motor 1801 while the throttle motor 1801 rotates with the upper and lower shafts.

A control system similar to that described above with respect to the permanent magnet piston motor may also be implemented in the permanent magnet rotary motor embodiments discussed above. For example, the motor 114 used in connection with the rotary motor 100 of FIG. 1 may drive the stator 108, during normal operation, at a predetermined RPM value, in response to a standard digital time command signal, as would be known to one of skill in the art having the present drawings, specifications, and claims before them. If it is desirable to stop or slow down the rotary motor 100, the digital time command signal may be modified to instruct the motor 114 to operate at a slower RPM value. The slower RPM value would cause the magnetic geometry between the rotor magnets 104 and stator magnets 110 rotation of the rotor 102 to re-align, resulting in a reduced motor speed.

The permanent magnet motor described above provides several advantages over prior art systems. First, the described permanent magnet motors are generally able to generate relatively large amounts of magnetic force from a relatively low exciting current because of the constant force of permanent magnets causing alternating attraction and repulsion of permanent magnets that have far stronger forces than are typically generated by electromagnets which generate magnetic fields from the same input current. This theory has many possibilities for commercial and industrial applications. Further, many such applications may be implemented using already existing technology, thus cutting down on development costs. For example, where the magnetic force produced by a permanent magnetic motor according to the invention is utilized as a driving force in, for example, electric vehicles in, a variety of technology developed for internal combustion piston engines for vehicles, such as power transmission mechanisms and so on, may also be used for electric vehicles with ease. Therefore, currently existing plants and equipment for manufacturing prior art internal combustion vehicles can also be applied to manufacturing electric vehicles. Also, the technology involved in connection with the present invention may further facilitate the development of both more powerful and long range electric vehicles.

FIG. 21 illustrates a vehicle driven by a permanent magnet motor. As shown vehicle 2100 includes a body 2110, a permanent magnet motor 2150 disposed within the body, electrical power storage 2115, such as a battery, which is operably connected to the permanent magnet motor 2150, a control system 2120 operably connected to the permanent magnet motor; and a propulsion system 2130 driven by the permanent magnet motor. The permanent magnet motor 2150 may be any of the embodiments of permanent magnet motor disclosed herein. The control system 2120 may also be one of the embodiments disclosed hereinabove.

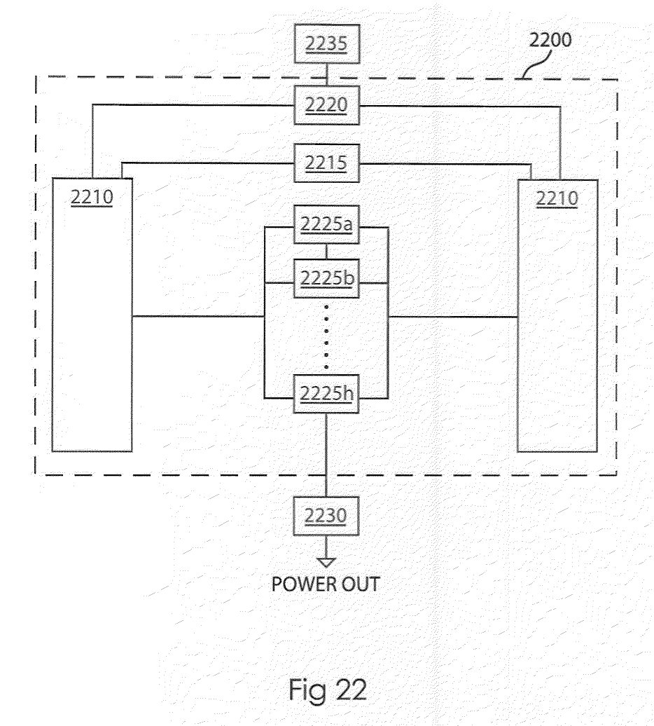

FIG. 22 illustrates another example of an application for a permanent magnet motor. In particular, FIG. 22 illustrates an example implementation of a power supply unit 2200 using one or more permanent magnet motors. The power supply unit 2200 may be used to power, for example, a plurality of computers, servers and/or other peripherals such as in a data center. It may also be used, for example, to power a compressor or pump such as for use in producing compressed gas or hydraulic output. Other implementations of such a power supply unit 2200 will be evident to one of ordinary skill in the art having the present drawings, specifications, and claims before them.

The power supply unit 2200 of FIG. 22 includes two permanent magnet motors 2210, however, one or more than two permanent magnet motors 2210 may be used. The power supply unit 2200 may further include electrical power storage 2215, such as a battery, which is operably connected to the permanent magnet motors 2210; a control system 2220 operably connected to the permanent magnet motors 2210; and one or more power generators 2225a-n driven by the permanent magnet motors 2210. The permanent magnet motors 2210 may be any of the embodiments of permanent magnet motor disclosed herein. The control system 2220 may also be one of the embodiments disclosed hereinabove. The power generators 2225a-n may be connected in series or parallel, and the output power generated by the power generators 2225a-n may then be supplied to one or more external electrical units (such as a rack of servers, computers, peripherals, etc.) via a connector unit 2230. Further, the control system 2220 may be operably coupled to a user input 2235 such as a keyboard and/or digital display.

As another advantage over conventional motors, the permanent magnet motors according to the present invention do not generally produce large amounts of heat as with conventional internal combustion piston engines. Therefore, cooling mechanisms for cooling vehicle engines are either not required, or may be smaller and less complex than those utilized with conventional engines, thereby contributing to making electric vehicles (particularly their bodies) more lightweight and compact in size. The lack of heat generation may also allow for the use of low temperature plastics and other low temperature materials to be used in the construction of the motors. Also, the permanent magnet motors according to the invention may eliminate various mechanical friction and other resistances which result naturally from the structure of conventional internal combustion piston engines. Thus, efficiency of energy consumption may be increased. Furthermore, because the permanent magnetic motor according to the invention is operable using relatively little electricity, it results in more environmentally friendly products.

Methods or processes in accordance with the various embodiments of the invention may be implemented by computer readable instructions stored in any media that is readable and executable by a computer system. A machine-readable medium having stored thereon instructions, which when executed by a set of processors, may cause the set of processors to perform the methods of the invention. A machine-readable medium may include any mechanism for storing or transmitting information in a form readable by a machine (e.g., a computer). A machine-readable medium may include read only memory (ROM); random access memory (RAM); magnetic disk storage media; optical storage media; or flash memory devices. Different known types of software may be used, as one of skill in the art having the present drawings, specifications, and claims before them would understand. For example PARALLAX® motor control or LABVIEW®, among other known controller software, may be used.

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art having the present drawings, specifications, and claims before them, the invention is susceptible to additional implementations or embodiments and certain of these details described in this application may be varied considerably without departing from the basic principles of the invention. It will thus be appreciated that those skilled in the art having the present drawings, specifications, and claims before them will be able to devise various arrangements which, although not explicitly described or shown herein, embody the principles of the invention and, thus, within its scope and spirit.

What is claimed is:

1. A piston motor comprising:
a piston assembly mounted on a crank shaft, the piston assembly comprising a cylinder having a first axis, a piston positioned inside the cylinder, and a piston magnet positioned inside the cylinder, the piston magnet having a first magnetic pole, and the piston configured to reciprocate axially within the cylinder;
a rotatable cam shaft disposed along a second axis perpendicular to the first axis; and
a cam magnet corresponding to the piston assembly, the cam magnet having a first magnetic pole and a second magnetic pole, and the cam magnet mounted on the cam shaft such that when the cam shaft rotates about the second axis, the first and second magnetic poles of the cam magnet alternatingly face the first magnetic pole of the corresponding piston magnet,
wherein field interactions between the first magnetic pole of the piston magnet and the magnetic poles of the corresponding cam magnet cause the corresponding piston to reciprocate within the cylinder in turn causing the crank shaft to rotate.

2. The piston motor of claim 1 further comprising a flywheel for maintaining the reciprocating movement of the piston within the cylinder.

3. The piston motor of claim 1, further comprising a booster coil coupled to the piston for enhancing output power of the piston motor.

4. The piston motor of claim 1 further comprising a plurality of piston assemblies mounted on the crank shaft.

5. The piston motor of claim 1 wherein the piston assemblies are disposed in two rows arranged in a v-shape, each row corresponding to a cam shaft.

6. The piston motor of claim 1 wherein the piston assemblies are disposed in a single row.

7. The piston motor of claim 1 further comprising a control device for changing a magnetic geometry relationship between the piston magnet and the cam magnet.

8. The piston motor of claim 7 wherein the control device comprises a drive belt in communication with the cam shaft and the crank shaft, a throttle unit disposed along the drive belt, and at least one idler unit disposed along the drive belt.

9. The piston motor of claim 8 wherein the magnetic geometry relationship between the piston magnet and the cam magnet changes upon actuation of the throttle unit.

10. The piston motor of claim 7 wherein the control devices comprises a throttle motor having a motor shaft rotationally coupled to an upper shaft and fixedly coupled to a lower shaft, and a motor control unit electrically connected to the throttle motor, wherein the upper shaft is coupled to the cam shaft and the lower shaft is couple to the crank shaft.

11. The piston motor of claim 10 wherein the magnetic geometry relationship between the piston magnet and the cam magnet changes in response to activation of the throttle motor.

12. The piston motor of claim 10 wherein the throttle motor is a stepper motor.

13. The piston motor of claim 1 further comprising a repulsion centering ring mounted around the piston for centering the piston within the cylinder.

14. The piston motor of claim 1 further comprising a plurality of wheels mounted around the piston for centering the piston within the cylinder.

15. The piston motor of claim 1 further comprising a linear bearing unit mounted on the piston and running along a guide track as the piston reciprocates axially within the cylinder.

16. A rotary motor comprising:
a rotor having a plurality of rotor magnets mounted thereon, each rotor magnet having a first magnetic pole and a second magnetic pole; and
a stator adjacent to the rotor comprising a stator magnet and a stator motor, the stator magnet having a first magnetic pole that is the same polarity as the first magnetic pole of the rotor magnets, and a second magnetic pole that is the same polarity as the second magnetic pole of the rotor magnets;
wherein the stator motor drives the stator, causing the rotor to rotate in response to alternating interactions between magnetic fields of the stator magnet and magnetic fields of the rotor magnet.

17. The rotary motor of claim 16, further comprising a booster coil coupled to the stator for enhancing output power of the rotary motor.

18. The rotary motor of claim 16 further comprising a plurality of stators adjacent to the rotor.

19. The rotary motor of claim 16 further comprising a plurality of rotors, each rotor corresponding to at least one stator.

20. The rotary motor of claim 16 wherein the stator motor is a stepper motor.

21. The rotary motor of claim 16 further comprising a controller for controlling the speed of the stator motor.

22. A vehicle comprising:
a body;
a permanent magnet motor disposed within the body;
electrical power storage operably connected to the permanent magnet motor;
a control system operably connected to the permanent magnet motor; and
a propulsion system driven by the permanent magnet motor.

23. The vehicle of claim 22 wherein the permanent magnet motor comprises:
a piston assembly mounted on a crank shaft, the piston assembly comprising a cylinder having a first axis, and a piston positioned inside the cylinder, the piston configured to reciprocate axially within the cylinder, wherein the piston comprises a piston magnet having a first magnetic pole;
a rotatable cam shaft disposed along a second axis perpendicular to the first axis; and
a cam magnet corresponding to the piston assembly, the cam magnet having a first magnetic pole and a second magnetic pole, and the cam magnet mounted on the cam shaft such that when the cam shaft rotates about the second axis, the first and second magnetic poles of the cam magnet alternatingly face the first magnetic pole of the corresponding piston magnet,
wherein field interactions between the first magnetic pole of the piston magnet and the magnetic poles of the corresponding cam magnet cause the corresponding piston to reciprocate within the cylinder in turn driving the propulsion system.

24. The vehicle of claim 22 wherein the permanent magnet motor comprises:
a rotor having a plurality of rotor magnets mounted thereon, each rotor magnet having a first magnetic pole and a second magnetic pole; and
a stator adjacent to the rotor comprising a stator magnet and a stator motor, the stator magnet having a first magnetic pole that is the same polarity as the first magnetic pole of the rotor magnets, and a second magnetic pole that is the same polarity as the second magnetic pole of the rotor magnets;
wherein the stator motor drives the stator, causing the rotor to rotate in response to alternating interactions between magnetic fields of the stator magnet and magnetic fields of the rotor magnet, the rotor driving the propulsion system.

25. A power supply unit comprising:
a permanent magnet motor;
electrical power storage operably connected to the permanent magnet motor;
a control system operably connected to the permanent magnet motor;
a power generator driven by the permanent magnet motor; and
output power to be supplied to an external electrical unit.
